(19) United States
(12) Patent Application Publication
(10) Pub. No.: US 2015/0245415 A1
(43) Pub. Date: Aug. 27, 2015

(54) FOOT WARMER AND ASSEMBLING FOOT WARMER SYSTEM

(71) Applicant: Wen-Ping WANG, Minneapolis, MN (US)

(72) Inventor: Wen-Ping WANG, Minneapolis, MN (US)

(21) Appl. No.: 14/622,946

(22) Filed: Feb. 16, 2015

(30) Foreign Application Priority Data
Feb. 26, 2014 (TW) 103203350
Jun. 3, 2014 (TW) 103209758
Sep. 22, 2014 (TW) 103216802

(51) Int. Cl. H05B 3/22; H05B 1/02

(52) U.S. Cl. CPC H05B 3/22; H05B 1/0252

(57) ABSTRACT

A foot warmer includes at least one conductive plate, at least one electric heater, a base and a power module. The electric heater is thermally connected to the conductive plate. The base includes an accommodating space and an inserting space. The accommodating space is for disposing the electric heater and the conductive plate therein. The power module is detachably connected to the inserting space of the base. The foot warmer can operate without restricts caused by the length of power line or the location of power.

### RELATED APPLICATIONS

This application claims priority to Taiwan Application Serial Number 103203350, filed Feb. 26, 2014, Taiwan Application Serial Number 103209758, filed Jun. 3, 2014 and Taiwan Application Serial Number 103216802, filed Sep. 22, 2014, which are herein incorporated by reference.

### BACKGROUND

1. Technical Field

The present disclosure relates to a warmer. More particularly, the present disclosure relates to a foot warmer with portable and rechargeable functionality.

2. Description of Related Art

The conventional foot warmer can stably provide a comfortable temperature to a user, but the foot warmer need to connect to the power through a power line for stable working. The conventional foot warmer is restricted by the length of power line and the location of power; therefore the above foot warmer has to use indoors or nearby the power. The above situation can be improved with an extension cord; however the lengthy extension cord is not only an inconvenience for using but also a potential factor of an electrical fire.

Moreover, the conventional foot warmer only provides one heat transfer mechanism, such as heat conduction or heat convection, to warm up the user. The heat conduction transfers the heat only by a contact between the foot warmer and the foot of the user, but it cannot effectively warm up the ambient temperature around the foot. The heat convention could warm up the ambient temperature around the foot and stably provides a predetermining temperature, but it takes a lot of time for warming up the ambient temperature to the predetermining temperature.

### SUMMARY

According to one aspect of the present disclosure, a foot warmer is provided. The foot warmer includes at least one conductive plate, at least one electric heater, a base and a power module. The electric heater is thermally connected to the conductive plate. The base includes an accommodating space and an inserting space. The accommodating space is for disposing the electric heater and the conductive plate therein. The power module is detachably connected to the inserting space of the base.

According to another aspect of the present disclosure, a foot warmer is provided. The foot warmer includes at least one conductive plate, at least one electric heater, a base and a power module. The electric heater is thermally connected to the conductive plate. The base includes an accommodating space and at least one handle. The accommodating space is for disposing the electric heater and the conductive plate therein. The handle is integrally disposed on the base. The power module disposed in the base.

According to still another aspect of the present disclosure, an assembling foot warmer system is provided. The assembling foot warmer system includes a bottom warmer and a lateral warmer. The bottom warmer includes at least one conductive plate, at least one electric heater, a base and a power module. The electric heater is thermally connected to the conductive plate. The base includes an accommodating space and an inserting space. The accommodating space is for disposing the electric heater and the conductive plate therein. The power module is detachably connected to the inserting space of the base. The lateral warmer includes a bottom base. The bottom base is detachably connected to the bottom warmer.

### BRIEF DESCRIPTION OF THE DRAWINGS

The present disclosure can be more fully understood by reading the following detailed description, with reference made to the accompanying drawings as follows:

FIG. 1 is an exploded view of a foot warmer according to one embodiment of the present disclosure;

FIG. 2 is a perspective view of the foot warmer in FIG. 1;

FIG. 3 is a schematic view of the power module and the base of the foot warmer in FIG.

FIG. 4 is a perspective view of a foot warmer according to another embodiment of the present disclosure;

FIG. 5 is a perspective view of a foot warmer according to still another embodiment of the present disclosure;

FIG. 6 is a schematic view of a cover 180 of the foot warmer 100 in FIG. 5;

FIG. 7 is a perspective view of a foot warmer according to yet another embodiment of the present disclosure;

FIG. 8 is a perspective view of a foot warmer according to further another embodiment of the present disclosure;

FIG. 9 is a perspective view of a foot warmer according to still another embodiment of the present disclosure;

FIG. 10 is a perspective view of an assembling foot warmer system according to one embodiment of the present disclosure; and

FIG. 11 is an exploded view of the assembling foot warmer system in FIG. 8.

### DETAILED DESCRIPTION

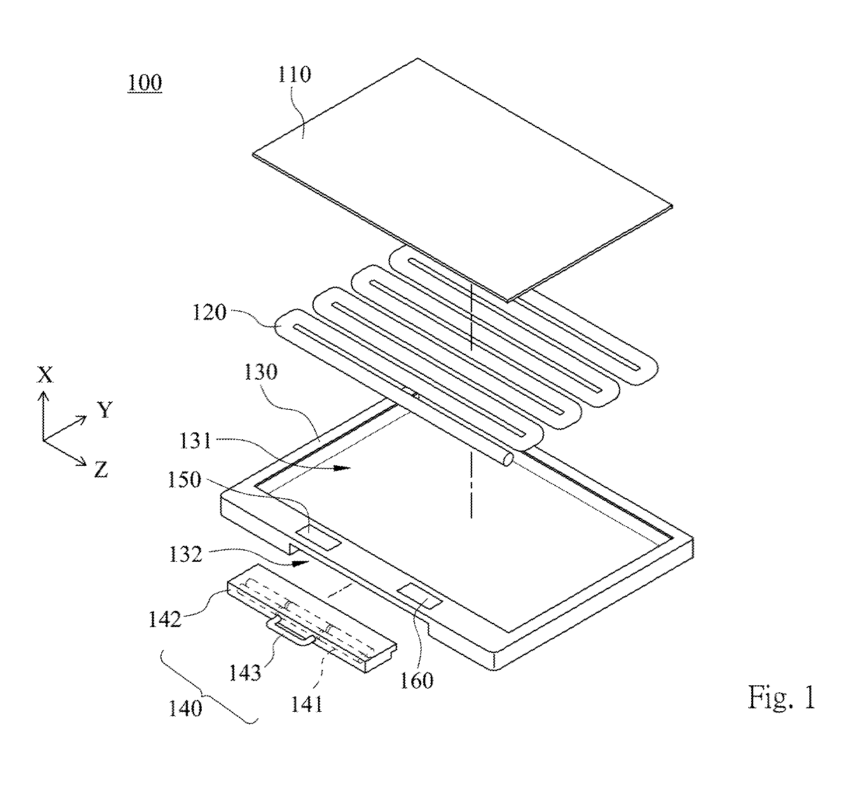

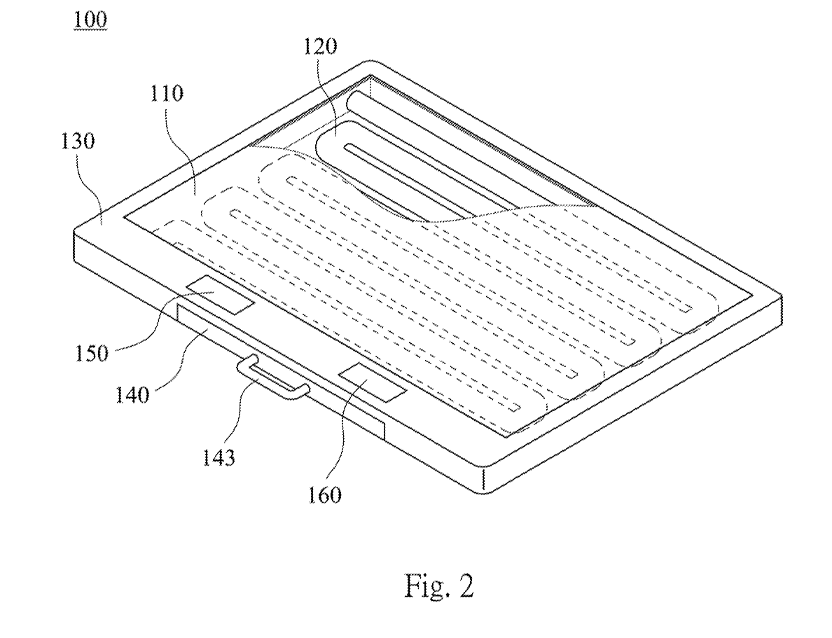

FIG. 1 is an exploded view of a foot warmer 100 according to one embodiment of the present disclosure. FIG. 2 is a perspective view of the foot warmer 100 in FIG. 1. The foot warmer 100 includes a conductive plate 110, an electric heater 120, a base 130 and a power module 140.

The conductive plate 110 is made of ceramic, so that the user can place their foot on the conductive plate 110 comfortably. Moreover, the conductive plate 110 can be coated with Teflon thereon for stain resistant, so that the corrosion on the conductive plate 110 which is due to the long time exposure to the air thereof can be prevented.

The electric heater 120 is thermally connected to the conductive plate 110. The electric heater 120 transforms electricity to heat by an electric heating wire. The electric heater 120 is zigzag disposed on the plane constituted by a direction Y and a direction Z, and is uniformly disposed below the conductive plate 110 for providing the heat to the conductive plate 110 uniformly. The electric heater 120 also can be an electric heating tube, a quartz heater, a ceramic heater or a polymer heater, and is not be limited hereto.

The base 130 is made of heat resistant plastic and for disposing the conductive plate 110 and the electric heater 120. The base 130 includes an accommodating space 131 and an inserting space 132. The electric heater 120 and the conductive plate 110 are disposed in the accommodating space 131 in a direction X, wherein the electric heater 120 is disposed in the accommodating space 131 and the conductive plate 110 fitting the shape of the accommodating space 131 is covered on the electric heater 120.

The power module 140 is detachably connected to the inserting space 132 of the base 130. The power module 140 can include at least one battery 141, a housing 142 and a handle 143, wherein, in the embodiment of FIG. 1, the power module 140 includes six batteries 141. The batteries 141 are electrically connected to the electric heater 120. The shape of the housing 142 is corresponded with the inserting space 132, and the housing 142 is disposed in the inserting space 132 in the direction Y. The housing 142 is for accommodating the batteries 141 and protecting the batteries 141 from environmental disturbance. The handle 143 is integrally disposed on the housing 142 and protruded from the inserting space 132, thus the user can hold the foot warmer 100 by the handle 143. Furthermore, the batteries 141 also can be directly connected to the electric heater 120 or be electrically connected to the electric heater 120 by other way, and will not be restricted by the connecting way in the embodiment of FIG. 1.

In the embodiment of FIG. 1, the foot warmer 100 can further include a switch 150 and a timer 160 which are disposed on the base 130. The switch 150 is for adjusting the heating efficiency and the timer 160 is for adjusting the operation time of the electric heater 120. Moreover, the switch 150 and the timer 160 can be controlled by a remote device (not shown herein).

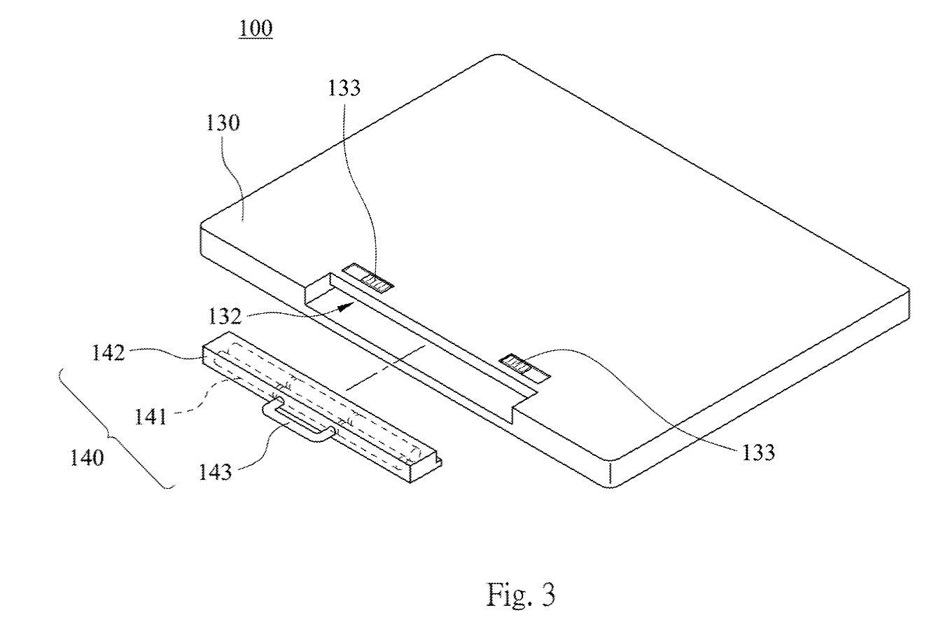

FIG. 3 is a schematic view of the power module 140 and the base 130 of the foot warmer 100 in FIG. 1. The housing 142 of the power module 140 is corresponded with the inserting space 132 and thereby the power module 140 can be accommodated in the inserting space 132. The base 130 can further include two buckles 133 for buckling the power module 140 to the base 130.

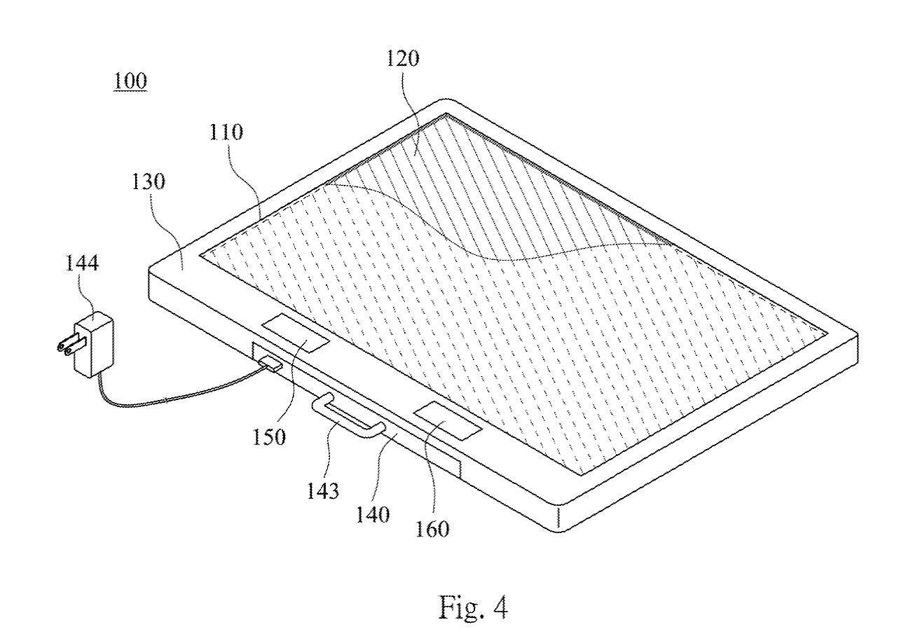

FIG. 4 is a perspective view of a foot warmer 100 according to another embodiment of the present disclosure. The electric heater 120 of the foot warmer 100 in FIG. 4 is a polymer heater made of polyimide, and transforms electricity to heat. The electric heater 120 is disposed under the conductive plate 110 and is fully fitted with the conductive plate 110. The electric heater 120 is thermally connected to the conductive plate 110 and provides the heat to the conductive plate 110 uniformly. The power module 140 can further include a power wire 144. The power wire 144 is detachably connected with the power module 140 and electrically connected with the battery, so that the battery can receive and store, a current from an external power through the power wire. 144, that is, the battery receives the external power by wired transmission.

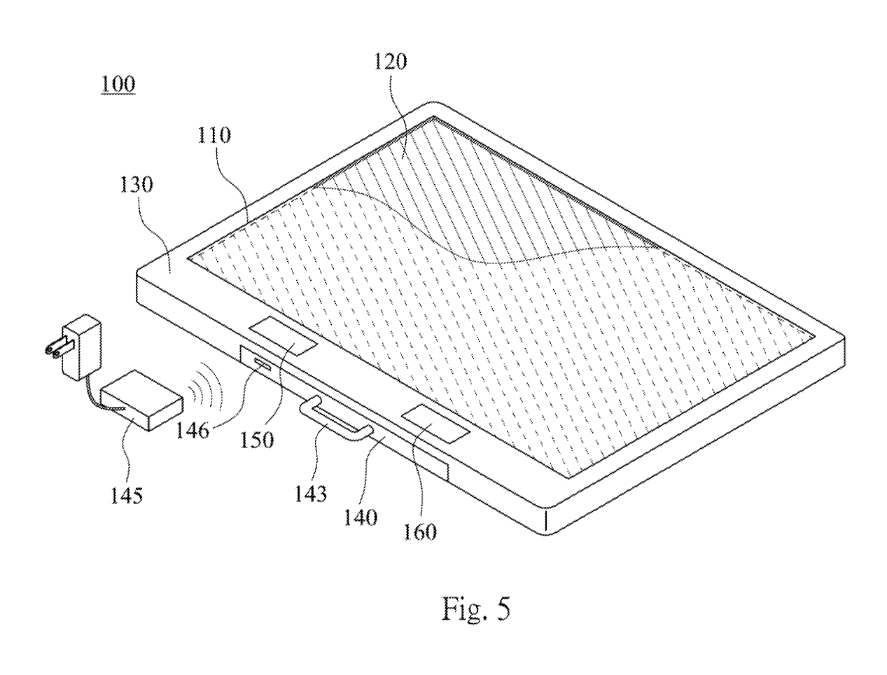

FIG. 5 is a perspective view of a foot warmer 100 according to still another embodiment of the present disclosure. In FIG. 5, the power module 140 of the foot warmer 100 can further include a transmitter 145 and a receiver 146. The transmitter 145 connects and transmits the electricity from an external power to the receiver 146 as an electromagnetic signal. The receiver 146 receives and transforms the electromagnetic signal into a current for storing in the battery, that is, the battery receives an external power by wireless transmission.

In the above embodiments, the power module 140 provides the electric power for operating the foot warmer 100 of the present disclosure. The operation of the foot warmer 100 would not be restricted by the length of power line or the location of power. Moreover, the battery of the power module 140 can receive and store electricity from the external power by wired transmission or wireless transmission.

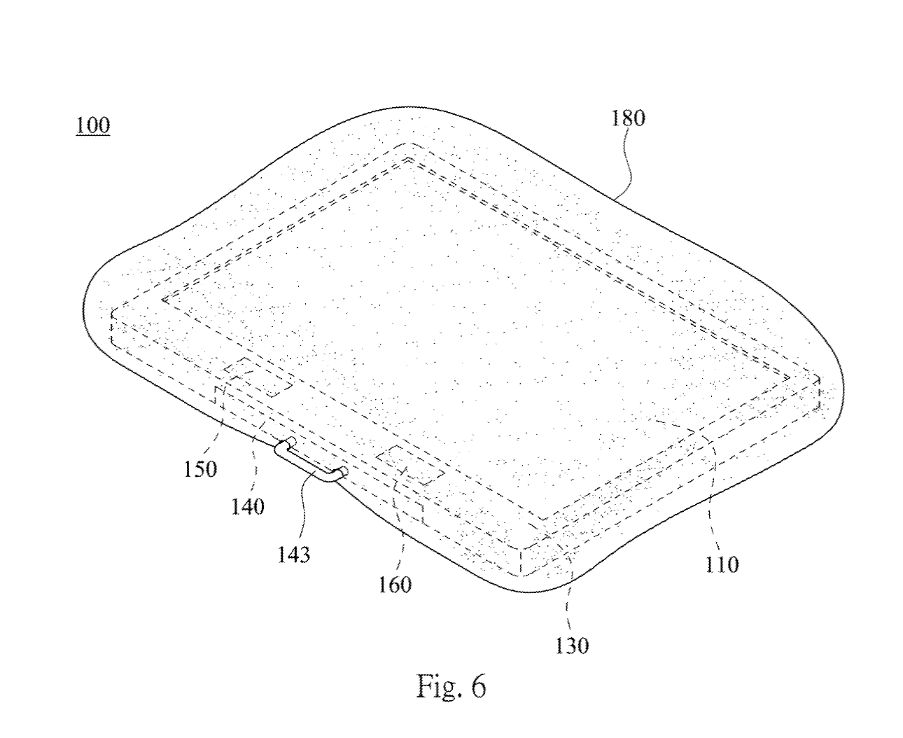

FIG. 6 is a schematic view of a cover 180 of the foot warmer 100 in FIG. 5. In FIG. 6, the foot warmer 100 can further include a cover 180 for covering the foot warmer. That is, the foot warmer 100 is disposed into the cover 180. The cover 180 is made of heat resistant rubber. The cover 180 is used to protect the foot warmer 100 away from water or dust. Moreover, the cover 180 can also be made of heat resistant plastic or fabric, and is not be limited hereto.

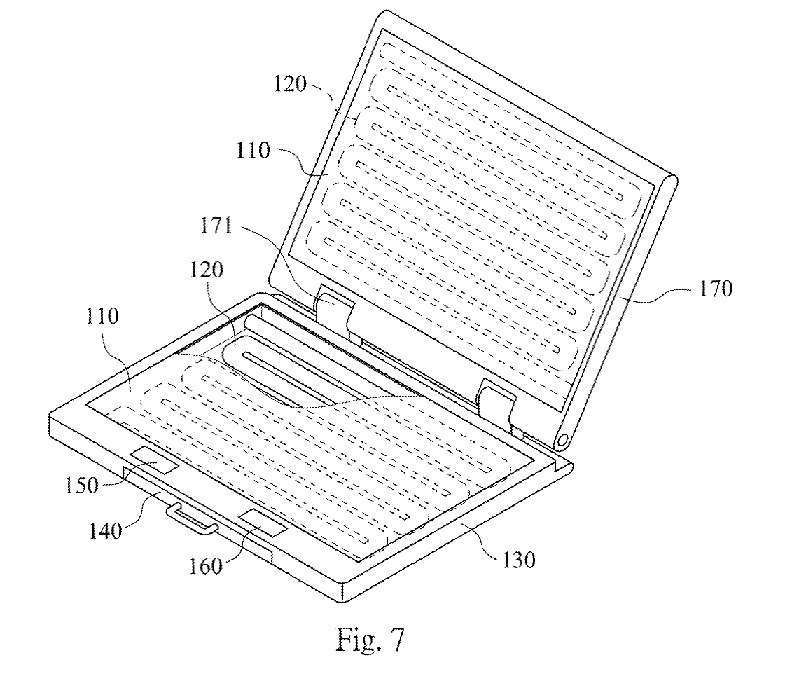

FIG. 7 is a perspective view of a foot warmer 100 according to yet another embodiment of the present disclosure. In FIG. 7, the foot warmer 100 can include two conductive plates 110, two electric heaters 120, a base 130, a power module 140, a switch 150 and a timer 160. The base 130 further includes a case 170 and two hinges 171. One of the electric heaters 120 and one of the conductive plates 110 are disposed in the accommodating space of the base 130. The other one of the electric heaters 120 and the other one of the conductive plates 110 are disposed on the case 170. The case 170 is pivotally connected with the base 130 via the two hinges 171. The power′ module 140, the switch 150 and the timer 160 are constructed and arranged as the above embodiments, and are not described again herein.

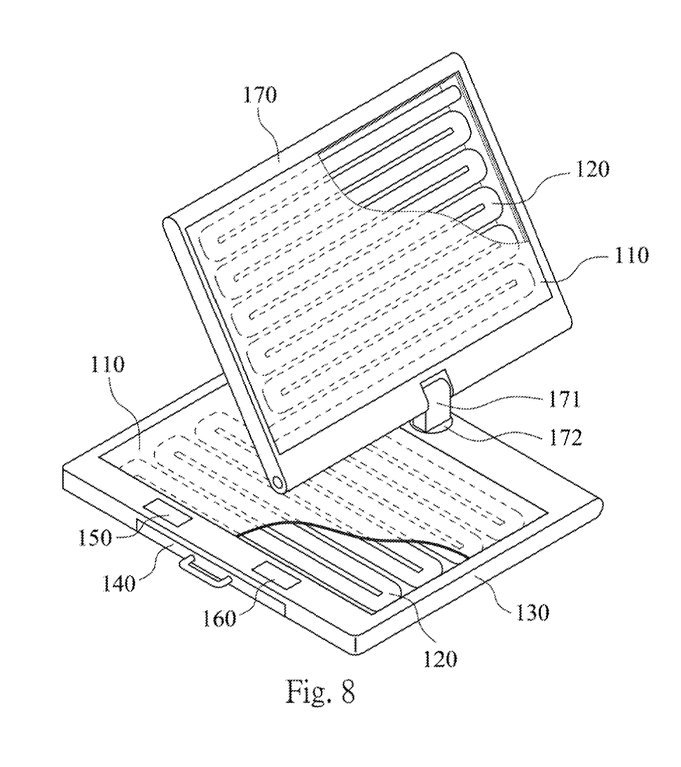

FIG. 8 is a perspective view of a foot warmer 100 according to further another embodiment of the present disclosure. In FIG. 8, the base 130 can further include a rotating base 172 and a hinge 171. The rotating base 172 is rotatably connected to the base 130, and one end of the hinge 171 is connected to the rotating base 172, the other end of the hinge 171 is pivotally connected to the case 170. Therefore, the case 170 can be rotated and pivoted relatively to the base 130.

In the embodiments of FIG. 7 and FIG. 8, the foot warmer 100 is foldable with the hinges 171 or the rotating base 172, so that the foot warmer 100 can prevent the user from inadvertently contacting the conductive plates 110. Moreover, the foot warmer 100 can reduce the volume thereof and be stored conveniently.

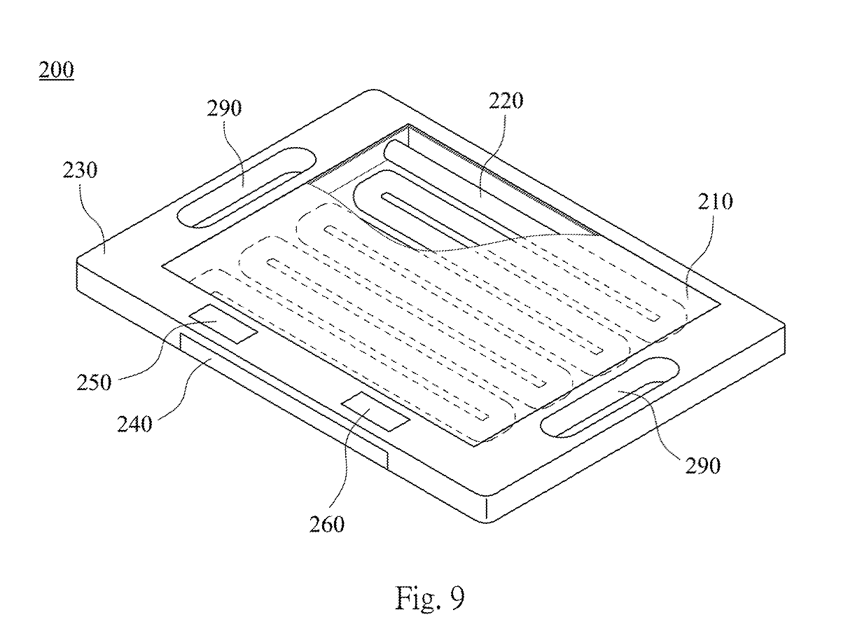

FIG. 9 is a perspective view of a foot warmer 200 according to still another embodiment of the present disclosure. The foot warmer 200 includes a conductive plate 210, an electric heater 220, a base 230 and a power module 240.

The conductive plate 210 is for placing the foot of a user. The conductive plate 210 is made of metal, ceramic, graphite or carbon fiber, and is not be limited hereto.

The electric heater 220 is thermally connected to the conductive plate 210. The electric heater 220 transforms electricity to heat by an electric heating wire or by other devices generating a heat. The electric heater 220 is zigzag and uniformly disposed below the conductive plate 210.

The base 230 includes an accommodating space and at least one handle 290, wherein the base 230 includes two handles 290 in FIG. 9. The accommodating space is for disposing the electric heater 220 and the conductive plate 210 therein. The handles 290 are integrally disposed on the base 230. Moreover, the base 230 is made of resistant plastic, heat resistant rubber or fabric, and is not be limited hereto.

The power module 240 is disposed in the base 230 for providing an electricity to the electric heater 220. The power module 240 can include at least one battery electrically connected to the electric heater 220. In addition, the battery can receives an external power by wired transmission or wireless transmission.

The conductive plate 210 further includes a switch 250 and a timer 260. The switch 250 and the timer 260 are constructed and arranged as the above embodiments, and are not described again herein.

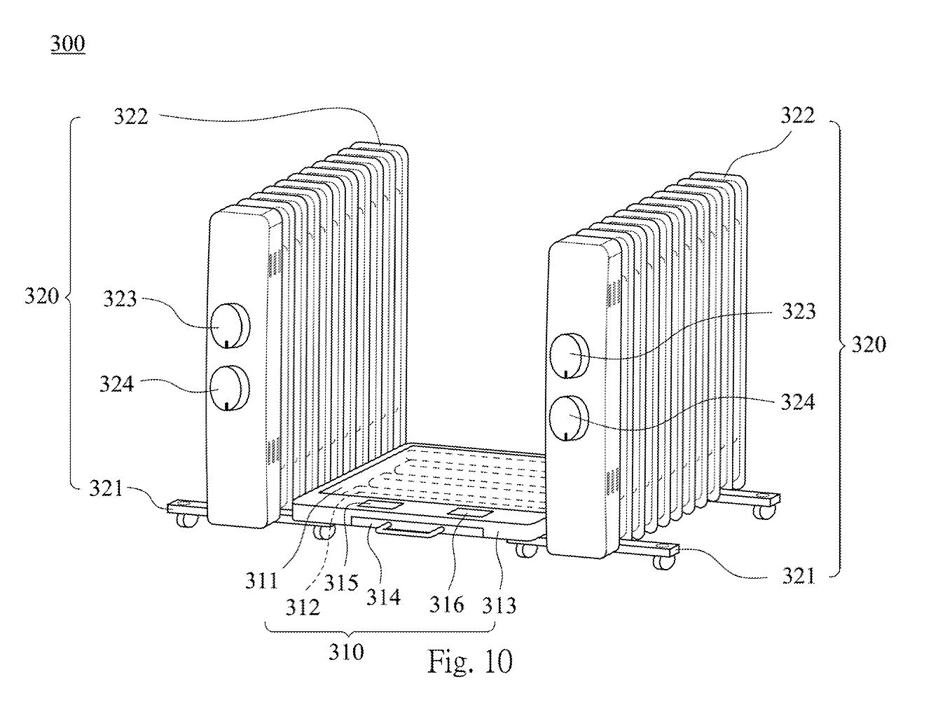

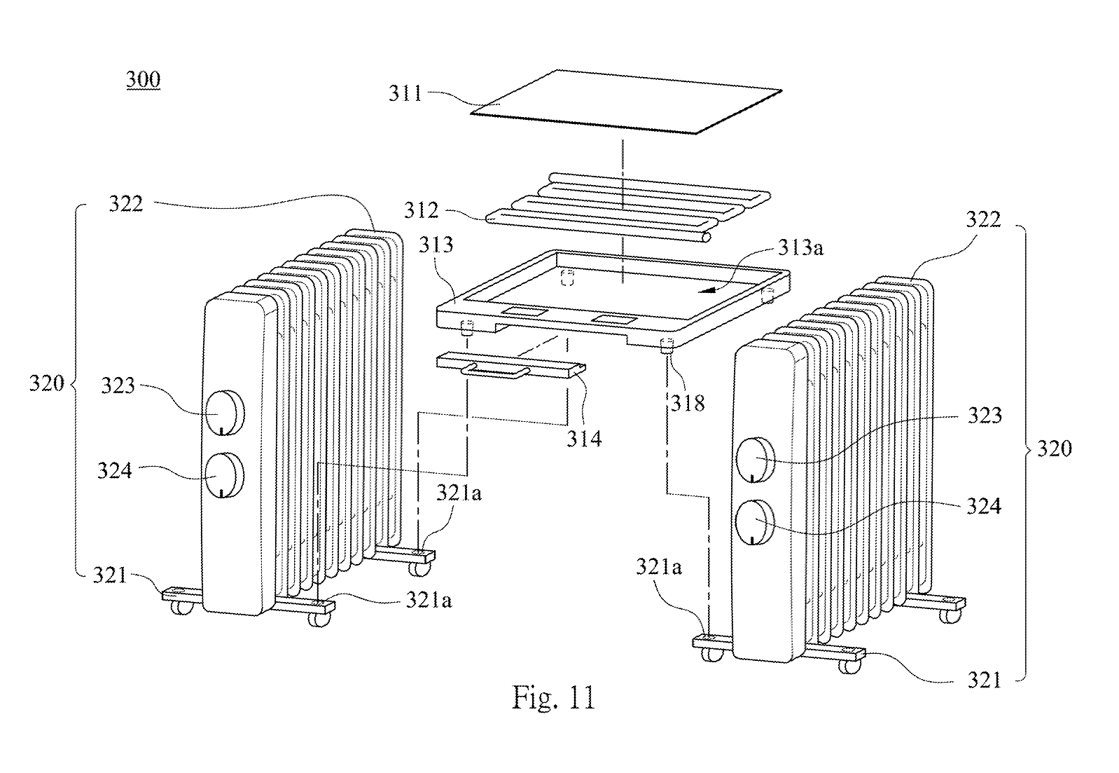

FIG. 10 is a perspective view of an assembling foot warmer system 300 according to one embodiment of the present disclosure. FIG. 11 is an exploded view of the assembling foot warmer system 300 in FIG. 10. The assembling foot warmer system 300 includes a bottom warmer 310 and at least one lateral warmer 320. In the embodiment of FIG. 10, the assembling foot warmer system 300 includes two lateral warmer 320 for providing lateral heats.

The bottom warmer 310 includes a conductive plate 311, an electric heater 312, a base 313, a power module 314. The conductive plate 311 is made of carbon fiber, so that the weight of the bottom warmer 310 can be reduced.

The electric heater 312 is thermally connected to the conductive plate 311. The electric heater 312 is an electric heating tube and transforms electricity to heat. The electric heater 312 is zigzag and uniformly disposed below the conductive plate 311. The bottom warmer 310 transfers the heat generated from the electric heater 312 to the user by heat conduction. The base 313 is made of heat resistant rubber, so that can prevent the bottom warmer 310 from malfunction caused by water. The base 313 includes an accommodating space (not labeled) and an inserting space (not labeled). The electric heater 312 is disposed in the accommodating space and the conductive plate 311 fitting the shape of the accommodating space is covered on the electric heater 312. Moreover, the electric heater 312 also can be an electric heating wire, a quartz heater, a ceramic heater or a polymer heater, and is not be limited hereto.

The power module 314 is detachably connected to the inserting space of the base 313. The power module 314 can include at least one battery (not shown), a housing (not labeled) and a handle (not labeled). The battery is electrically connected to the electric heater 312. The housing is for accommodating and protecting the battery and is disposed in the inserting space. The handle is integrally disposed on the housing and protruded from the inserting space, thus the user can hold the bottom warmer 310 by the handle. Furthermore, the battery can receive and store electricity from an external power by wired transmission or wireless transmission.

Each of the lateral warmers 320 includes a bottom base 321 which is detachably connected to the bottom warmer 310 and a heater (not shown) which is disposed in the bottom base 321. In FIG. 11, four projections 318 are disposed on and protruded from an outer surface which is opposite to the accommodating space of the base 313. Each of the bottom bases 321 of the lateral warmers 320 can include two depressions 321a, so that each projection 318 can be inserted into each depression 321a for connecting each bottom warmer 320 and each bottom warmer 310.

Furthermore, each of the lateral warmers 320 can include a plurality of fins 322, a switch 323 and a timer 324, wherein the fins 322 are disposed on the bottom bases 321 and thermally connected to the heater, and the switch 323 and the timer 324 are connected to the fins 322 for controlling the heat generated from the fins 322. The lateral warmers 320 generate a heat by a ceramic heater and transfer the heat by heat convention. The lateral warmers 320 can be an electric heating wire, an electric heating tube, a quartz heater or a polymer heater, and is not be limited hereto.

In the embodiment of FIG. 10, the bottom warmer 310 can further include a switch 315 and a timer 316. The switch 315 is disposed on the base 313 and is for adjusting the heating efficiency of electric heater 312. The timer 316 is disposed on the base 313 and is for adjusting the operation time of the electric heater 312.

Further, each of the lateral arm 320 can further include a battery to receive and store electricity from an external power by wired transmission or wireless transmission.

Moreover, the bottom warmer 310 further includes a cover for covering the bottom warmer 310, such as shown in FIG. 6. The cover can be made of heat resistant plastic, heat resistant rubber or fabric, and is not be limited hereto. 310

In the embodiment of FIG. 10, the bottom warmer 310 directly warms up the foot by heat conduction and the lateral warmers 320 stably warm up the ambient temperature around the foot by heat convention. The assembling foot warmer system 300 provides two heat transfer mechanism, thus the user can be immediately warm up by the bottom warmer 310 and the ambient temperature around the foot can be steadily maintain at a predetermining temperature.

Furthermore, the bottom warmer 310 can be constructed and arranged as the embodiments in FIG. 7 and FIG. 8. The bottom warmer 310 not only can be foldable and portable, but also can reduce the volume thereof and be stored conveniently.

As mentioned of the embodiments, the present disclosure has the following advantages: 1. The foot warmer 100 and the assembling foot warmer system 300 can operate without restricts caused by the length of power line or the location of power. 2. The foot warmer 100 and the assembling foot warmer system 300 are rechargeable by wired transmission or wireless transmission. 3. The foot warmer 100 and the assembling foot warmer system 300 can warm up the foot and surrounding thereof immediately and steadily. 4. The foot warmer 100 and the assembling foot warmer system 300 are portable, foldable and detachable for convenient storing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A foot warmer, comprising:
at least one conductive plate;
at least one electric heater thermally connected to the conductive plate;
a base comprising:
an accommodating space for disposing the electric heater and the conductive plate therein; and
an inserting space; and
a power module detachably connected to the inserting space of the base.

2. The foot warmer of claim 1, wherein the power module comprises:
at least one battery electrically connected to the electric heater;
a housing for accommodating the battery, and disposed in the inserting space; and
a handle integrally disposed on the housing and protruded from the inserting space.

3. The foot warmer of claim 2, wherein the battery receives an external power by wired transmission or wireless transmission.

4. The foot warmer of claim 1, wherein the base further comprises at least one buckle for buckling the power module to the base.

5. The foot warmer of claim 1, further comprising:
a cover for covering the foot warmer, and made of heat resistant plastic heat resistant rubber or fabric.

6. The foot warmer of claim 1, wherein the conductive plate is made of metal, ceramic, graphite or carbon fiber.

7. The foot warmer of claim 1, wherein the electric heater is an electric heating wire, an electric heating tube, a quartz heater, a ceramic heater or a polymer heater.

8. The foot warmer of claim 1, wherein a number of each of the electric heater and the conductive plates is two, and the base further comprises a case pivotally connected to the base, wherein one of the electric heaters and one of the conductive plates are disposed in the accommodating space, the other one of the electric heaters and the other one of the conductive plates are disposed on the case.

9. The foot warmer of claim 8, wherein the base further comprises a rotating base rotatably connected the case and the base and for relatively rotating the case to the base.

10. A foot warmer, comprising:
at least one conductive plate;
at least one electric heater thermally connected to the conductive plate;
a base comprising:
an accommodating space for disposing the electric heater and the conductive plate therein; and
at least one handle integrally disposed on the base; and
a power module disposed in the base.

11. The foot warmer of claim 10, wherein the power module comprises at least one battery electrically connected to the electric heater.

12. The foot warmer of claim 11, wherein the battery receives an external power by wired transmission or wireless transmission.

13. An assembling foot warmer system, comprising:
a bottom warmer comprising:
at least one conductive plate;
at least one electric heater thermally connected to the conductive plate; and
a base comprising:
an accommodating space for disposing the electric heater and the conductive plate therein; and
an inserting space; and
a power module detachably connected to the inserting space of the base; and
at least one lateral warmer for providing a lateral heat, and the lateral warmer comprising:
a bottom base detachably connected to the bottom warmer; and
a heater disposed on the bottom base.

14. The assembling foot warmer system of claim 13, wherein the power module comprises:
at least one battery electrically connected to the electric heater;
a housing for accommodating the battery, and disposed in the inserting space; and
a handle integrally disposed on the housing and protruded from the inserting space.

15. The assembling foot warmer system of claim 14, wherein the battery receives an external power by wired transmission or wireless transmission.

16. The assembling foot warmer system of claim 13, wherein the lateral warmer generates the lateral heat by an electric heating wire, an electric heating tube, a quartz heater, a ceramic heater or a polymer heater.

17. The assembling foot warmer system of claim 13, wherein the lateral warmer further comprises a plurality of fins thermally connected to the heater.

18. The assembling foot warmer system of claim 13, wherein the bottom warmer further comprises:
a cover for covering the bottom warmer, and made of heat resistant plastic, heat resistant rubber or fabric.

19. The assembling foot warmer system of claim 13, wherein the electric heater of the bottom warmer is an electric heating wire, an electric heating tube, a quartz heater, a ceramic heater or a polymer heater.

20. The assembling foot warmer system of claim 13, wherein the bottom warmer further comprises:
a switch disposed on the base; and
a timer disposed on the base.
